(19) United States
(12) Patent Application Publication
(10) Pub. No.: US 2025/0313780 A1
(43) Pub. Date: Oct. 9, 2025

(54) SOLVENT COMPOSITIONS AND ASSOCIATED METHODS

(71) Applicant: Shellef Holdings Inc., Kingston, NY (US)

(72) Inventors: Dov Shellef, Rock Tavern, NY (US); Edo Shellef, Flower Mound, TX (US)

(21) Appl. No.: 19/173,313

(22) Filed: Apr. 8, 2025

Related U.S. Application Data
(60) Provisional application No. 63/575,906, filed on Apr. 8, 2024.

(51) Int. Cl. C11D 7/50; B29C 33/60; B29C 33/72; C08J 9/14; C09D 7/20; C09K 5/10; C11D 7/30; C11D 17/00

(52) U.S. Cl. CPC C11D 7/5018; B29C 33/60; B29C 33/722; C08J 9/144; C09D 7/20; C09K 5/10; C11D 7/30; C11D 17/0043; C08J 2203/162; C08J 2203/182; C09K 2205/126; C09K 2205/34

(57) ABSTRACT

A nonflammable solvent composition comprises, based on the total weight of trans-1,2-dichloroethylene, (E)-1-chloro-2,3,3-trifluoroprop-1-ene, and (Z)-1-chloro-2,3,3-trifluoroprop-1-ene: about 80 wt. % to about 99.99 wt. % of trans-1,2-dichloroethylene; and about 0.01 wt. % to about 20 wt. % of at least one of (E)-1-chloro-2,3,3-trifluoroprop-1-ene or (Z)-1-chloro-2,3,3-trifluoroprop-1-ene; wherein the nonflammable solvent composition has no fire point over a temperature range of 10° C. to the boiling point of the solvent composition, measured according to any one or more of ASTM D92-18, ASTM D1310-14, or ASTM D56-22. Methods for preparing a nonflammable solvent composition from trans-1,2-dichloroethylene and for increasing the fire point of trans-1,2-dichloroethylene comprises mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene to form a nonflammable solvent composition having no fire point over a temperature range of 10° C. to the boiling point of the solvent composition.

### BACKGROUND

This disclosure relates to a nonflammable solvent composition, and coating, mold release, aerosol cleaner, and cleaning compositions comprising the nonflammable solvent composition. Methods for preparing the nonflammable solvent composition, for increasing the fire point of trans-1,2-dichloroehtylene and for increasing, eliminating, or suppressing the flash point of trans-1,2-dichloroethylene are also disclosed. Methods for cleaning a surface of an article, for coating a substrate, and for transferring heat using the nonflammable solvent composition are also disclosed.

Trans-1,2-dichloroethylene (t-DCE) is a chlorinated solvent with a boiling point of 48° C. that can be used as a cleaner, e.g., cleaning in a vapor degreaser. In particular, t-DCE has good solubilizing power, especially for fatty substances, such as lubricants, oils, and fats. However, its use has been relatively limited for cleaning purposes because, with a flash point of about 2° C. (36° F.) as measured by ASTM D-56, t-DCE is highly flammable. Thus, there is a need in the art for nonflammable solvent compositions consisting primarily of t-DCE. As used herein, a nonflammable solvent composition refers to a solvent composition that is nonflammable over a temperature range of 10° C. to the boiling point of the composition, measured according to any one or both of ASTM D-92-18, ASTM D-1310-14, or ASTM D56-22. In other words, the solvent composition has no fire point over a temperature range of 10° C. to the boiling point of the composition, measured according to any one or more of ASTM D-92-18, ASTM D-1310-14, or ASTM D-56-22. Fire point is defined as the lowest temperature at which a liquid will continue to burn for at least five seconds after ignition by an open flame. When a solvent composition has no fire point over a temperature range of 10° C. to the boiling point of the composition, that indicates that the solvent composition will not continue to burn for at least five seconds, even if it is ignited by an open flame. Instead, the solvent will not ignite or will self-extinguish if ignited.

Prior methods to provide nonflammable t-DCE solvent compositions have focused on mixing it with large quantities of a nonflammable solvent having a volatility similar to that of t-DCE. For example, such volatile solvents included hydrochlorofluorocarbons (HCFCs), hydrofluorocarbons (HFCs) and the like. These methods relied upon forming azeotropic blends of t-DCE and other components to raise the flash point of the t-DCE. By definition, azeotropic mixtures maintain substantially the same composition in the liquid phase and in the vapor phase at the boiling point of the azeotrope. These azeotropic compositions can behave as single solvent degreasing solutions and, as such, are used as solvents in degreasing metal components and cleaning various surfaces in systems where the solvent may be required to continuously evaporate and condense without fractionation. However, the use of significant proportions of popular HCFCs and HFCs have become disfavored because of their environmental impact: HCFCs have ozone depletion characteristics and non-flammable HFCs are considered “super greenhouse” gases with high global warming potentials. The vast majority of prior methods rely on PFAS (poly/per-fluorinated alkanes), which are being eliminated from use through improved regulations and environmental policies.

Other azeotropes and near-azeotropes based upon HFCs and t-DCE have been developed. Unfortunately, many HFCs exhibit combinations of properties which are not optimal for safe cleaning. For example, difluoroethane (HFC-152a) and 1,1,1-trifluoropropene (HFO-1243zf) are both flammable and both exhibit very low boiling points. Their very low boiling points make these azeotropes suitable for use as blowing agents, but they are not viable for use in many cleaning applications. Also, although there are distinct advantages to using such azeotropes and near-azeotropes, azeotropes and near-azeotropes have limited versatility and usefulness as they represent a naturally occurring, fixed weight ratio of components, sacrificing desirable properties, such as higher solvency, achieved with other ratios of the components.

There remains a need in the art for solvent compositions comprising t-DCE that not only has strong solvency (cleaning power) but are also nonflammable. The nonflammable solvent compositions should also have a low environmental impact (i.e., they should not deplete the ozone layer. The nonflammable solvent compositions should also have multiple applications, for example in cleaning compositions, including aerosol cleaners, as blowing agents, or as coating solvents.

### SUMMARY

A nonflammable solvent composition comprises, based on the total weight of trans-1,2-dichloroethylene, (E)-1-chloro-2,3,3-trifluoroprop-1-ene, and (Z)-1-chloro-2,3,3-trifluoroprop-1-ene: about 80 wt. % to about 99.99 wt. % of trans-1,2-dichloroethylene; and about 0.01 wt. % to about 20 wt. % of at least one of (E)-1-chloro-2,3,3-trifluoroprop-1-ene or (Z)-1-chloro-2,3,3-trifluoroprop-1-ene; wherein the nonflammable solvent composition has no fire point over a temperature range of 10° C. to the boiling point of the solvent composition, measured according to any one or more of ASTM D92-18, ASTM D1310-14, or ASTM D56-22.

A method of preparing a nonflammable solvent composition from trans-1,2-dichloroethylene, comprises mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the solvent composition, measured according to any one or more of ASTM D92-18, ASTM D1310-14, or ASTM D56-22.

A method for increasing the fire point of trans-1,2-dichloroethylene comprises: mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition is nonflammable over a temperature range of 10° C. to the boiling point of the composition, measured according to any one or more of ASTM D-92-18, ASTM D-1310-14, or ASTM D-56-22, and has no fire point at the boiling point of the composition.

### DETAILED DESCRIPTION

Disclosed herein are nonflammable solvent compositions comprising t-DCE and at least one of (E)-1-chloro-2,3,3-trifluoroprop-1-ene or (Z)-1-chloro-2,3,3-trifluoroprop-1-enehaving many advantageous properties. The nonflammable solvent compositions exhibit no fire point over a temperature range of 10° C. to the boiling point of the composition, measured according to any one or more of ASTM D-92-18, ASTM D-1310-14, or ASTM D-56-22, have low environmental impact in that they do not deplete the ozone layer, are not PFAS, and have multiple end-use applications, for example as cleaners, including aerosol cleaners, as blowing agents, and as coating solvents.

A solvent or solvent composition, i.e. a liquid, as defined herein is a nearly incompressible fluid that conforms to the shape of its container but retains a nearly constant volume independent of pressure.

As used herein, “azeotrope” and “azeotropic composition” refer to an admixture of two or more substances in which the admixture distills without substantial compositional change and behaves as a constant boiling composition. Constant boiling compositions, which are characterized as azeotropic, exhibit either a maximum or a minimum boiling point, as compared with that of the non-azeotropic mixtures of the same substances. Azeotropic compositions as used herein include homogeneous azeotropes, which are liquid admixtures of two or more substances that behave as a single substance, in that the vapor, produced by partial evaporation or distillation of the liquid, has the same composition as the liquid. For example, in homogeneous azeotropes, the com ponents are completely, or nearly completely, miscible in one another. Therefore, homogeneous azeotropes form a single liquid phase.

As used herein, the terms “azeotrope-like composition” and “near-azeotrope” both refer to a constant boiling, or substantially constant boiling, liquid admixture of two or more substances that behaves as a single substance. One way to characterize an azeotrope-like composition is that the vapor produced by partial evaporation or distillation of the liquid has substantially the same composition as the liquid from which it was evaporated or distilled. That is, the admixture distills/refluxes without substantial composition change. For example, the total compositional change between the vapor and the liquid after the admixture distills/refluxes is about 10% or less, or about 5% or less. A composition is azeotrope-like if, for example, after 50 wt. % of the composition is removed, such as by evaporation or boiling, the difference in vapor pressure between the original composition and the composition remaining after 50 wt. % of the original composition has been removed by evaporation or boiling off is less than about 10%.

As used herein, “non-azeotropic” refers to solvent mixtures that do not maintain substantially the same composition in the liquid phase and in the vapor phase at the boiling point of the mixture. Any mixture that is not an azeotrope and cannot be strictly defined as azeotrope-like, is considered a non-azeotrope.

As used herein, the term, “nonflammable” in relation to the solvent composition refers to the absence of a fire point over a temperature range of 10° C. to the boiling point of the solvent composition, measured according to any one or more of ASTM D-92-18, ASTM D-1310-14, or ASTM D-56-22, and in particular one or both of ASTM D-92-18 or ASTM D-1310-14. Generally, fire point is measured at standard atmospheric pressure.

In some embodiments, the solvent composition will satisfy the criteria for nonflammability as defined by any one or more of ASTM D3278, D3828, D3941 or D93-20. In other embodiments, e.g. when the composition is in the form of an aerosol, the composition will satisfy the criteria for nonflammability as defined in ASTM D3065-01.

The nonflammable solvent composition can comprise about 50 wt. % or more of trans-1,2-dichloroethylene (t-DCE); and about 0.01 wt. % to about 50 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene. Within these ranges, the nonflammable solvent composition can comprise greater than or equal to 0.01 wt. % and less than or equal to 40, 30, 20, 10, or 5, 3, 2, 1, 0.5, or 0.25 wt. % of at least one of (E)-1-chloro-2,3,3-trifluoroprop-1-ene or (Z)-1-chloro-2,3,3-trifluoroprop-1-ene. The nonflammable solvent composition can also comprise greater than or equal to 60, 70, 80, 90, 95, 97, 98, 99, 99.5, or 99.75 wt. % and less than or equal to 99.9 or 99.99 wt. % of t-DCE.

In some embodiments, the nonflammable solvent composition comprises, based on the total weight of trans-1,2-dichloroethylene, (E)-1-chloro-2,3,3-trifluoroprop-1-ene, and (Z)-1-chloro-2,3,3-trifluoroprop-1-ene, about 80 to about 99.99 wt. % of trans-1,2-dichloroethylene; and about 0.01 wt. % to about 20 wt. % of at least one of (E)-1-chloro-2,3,3-trifluoroprop-1-ene or (Z)-1-chloro-2,3,3-trifluoroprop-1-ene. In some embodiments, the nonflammable solvent composition has no fire point over a temperature range of 10° C. to the boiling point of the solvent composition, measured according to any one or more of ASTM D92-18, ASTM D1310-14, or ASTM D56-22. In some embodiments, the nonflammable solvent composition comprises, based on the total weight of trans-1,2-dichloroethylene, (E)-1-chloro-2,3,3-trifluoroprop-1-ene, and (Z)-1-chloro-2,3,3-trifluoroprop-1-ene, greater than 97 wt. % to about 99.99 wt. % of trans-1,2-dichloroethylene; and about 0.01 wt. % to less than 3 wt. % of at least one of (E)-1-chloro-2,3,3-trifluoroprop-1-ene or (Z)-1-chloro-2,3,3-trifluoroprop-1-ene. In some embodiments, the nonflammable solvent composition comprises, based on the total weight of trans-1,2-dichloroethylene, (E)-1-chloro-2,3,3-trifluoroprop-1-ene, and (Z)-1-chloro-2,3,3-trifluoroprop-1-ene, greater than 99 wt. % to about 99.99 wt. % of trans-1,2-dichloroethylene; and about 0.01 wt. % to less than 1 wt. % of at least one of (E)-1-chloro-2,3,3-trifluoroprop-1-ene or (Z)-1-chloro-2,3,3-trifluoroprop-1-ene.

T-DCE by itself is an effective solvent for cleaning, an effective blowing agent for foams, and an effective refrigerant. However in practice, handling of t-DCE is problematic because with its relatively low flash point of about 2° C. (36° F.) as measured according to ASTM D56-22, t-DCE is considered highly flammable. Current United States Department of Transportation regulations designate liquids having a flash point less than 60° C. as flammable for transportation purposes. Thus, not only is transportation of t-DCE hazardous, but so too is its use as a cleaning agent or blowing agent, where evaporation of the t-DCE occurs. Thus there is a long-standing need in the art to render t-DCE nonflammable. Many methods to do so require mixing t-DCE with large quantities of a nonflammable cosolvent having volatility similar to t-DCE. Other methods relied on forming azeotropic blends of t-DCE with cosolvents to raise its flash point. However each of these cosolvents and methods have one or more drawbacks.

In an effort to address the flammability of t-DCE and the drawbacks associated with other methods to do so, disclosed herein is a method for increasing the fire point of trans-1,2-dichloroethylene comprises mixing trans-1,2-dichloroethylene with about 0.01 wt. % to about 50 wt. % of at least one of (E)-1-chloro-2,3,3-trifluoroprop-1 or (Z)-1-chloro-2,3,3-trifluoroprop-1-ene, based on the total weight of the trans-1,2-dichloroethylene, (E)-1-chloro-2,3,3-trifluoroprop-1-ene, and (Z)-1-chloro-2,3,3-trifluoroprop-1-ene, wherein the nonflammable solvent composition has no fire point over a temperature range of 10° C. to the boiling point of the solvent composition, measured according to any one or more of ASTM D92-18, ASTM D1310-14, or ASTM D56-22. Within this range, the trans-1,2-dichloroethylene can comprise greater than or equal to 0.01 wt. % and less than or equal to 40, 30, 20, 10, or 5, 3, 2, 1, 0.5, or 0.25 wt. % of at least one of (E)-1-chloro-2,3,3-trifluoroprop-1-ene or (Z)-1-chloro-2,3,3-trifluoroprop-1-ene. In some embodiments, the method for increasing the fire point of trans-1,2-dichloroethylene comprises mixing trans-1,2-dichloroethylene with about 0.01 wt. % to about 20 wt. % of at least one of (E)-1-chloro-2,3,3-trifluoroprop-1-wherein the nonflammable solvent composition has no fire point over a temperature range of 10° C. to the boiling point of the solvent composition, measured according to any one or more of ASTM D92-18, ASTM D1310-14, or ASTM D56-22. In other embodiments, the method for increasing the fire point of trans-1,2-dichloroethylene comprises mixing trans-1,2-dichloroethylene with about 0.01 wt. % to less than 3 wt. % of at least one of (E)-1-chloro-2,3,3-trifluoroprop-1-ene or (Z)-1-chloro-2,3,3-trifluoroprop-1-ene, wherein the nonflammable solvent composition has no fire point over a temperature range of 10° C. to the boiling point of the solvent composition, measured according to any one or more of ASTM D92-18, ASTM D1310-14, or ASTM D56-22.

The ambient pressure can affect the fire point. Therefore, in some embodiments, the method for increasing the fire point of trans-1,2-dichloroethylene comprises mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the composition and over a pressure range of about 0.5 to about 2 atmospheres, measured according to any one or more of ASTM D-92-18, ASTM D-1310-14, or ASTM D-56-22.

Thus, the nonflammable solvent composition can exhibit no flash point from −20° C. to 48° C. over a pressure range of about 0.5 to about 2 atmospheres.

In some embodiments, the nonflammable solvent composition comprises at least one of (E)-1-chloro-2,3,3-trifluoroprop-1-ene or (Z)-1-chloro-2,3,3-trifluoroprop-1-ene, but not perfluoro(2-methyl-3-pentanone). In other embodiments, the nonflammable solvent composition comprises perfluoro(2-methyl-3-pentanone), but not at least one of (E)-1-chloro-2,3,3-trifluoroprop-1-ene or (Z)-1-chloro-2,3,3-trifluoroprop-1-ene. Thus, the nonflammable solvent composition can comprise about 92 to about 99.99 wt. % of t-DCE; and about 0.01 to about 8 wt. % perfluoro(2-methyl-3-pentanone); wherein the solvent composition is a homogeneous mixture of t-DCE and perfluoro(2-methyl-3-pentanone). The nonflammable solvent composition can be azeotropic, near-azeotropic, or non-azeotropic. In some embodiments, the nonflammable solvent composition is non-azeotropic and does not include azeotropic or quasi-azeotropic mixtures. “Non-azeotropic” refers to solvent mixtures that do not maintain substantially the same composition in the liquid phase and in the vapor phase at the boiling point of the mixture.

A method for preparing a nonflammable solvent composition from trans-1,2-dichloroethylene comprises: mixing the trans-1,2-dichloroethylene with a about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the solvent composition, measured according to any one or more of ASTM D92-18, ASTM D1310-14, or ASTM D56-22.

Also disclosed herein is a method for preparing the nonflammable solvent composition from trans-1,2-dichloroethylene comprises mixing the trans_1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the solvent composition, measured according to any one or more of ASTM D92-18, ASTM D1310-14, or ASTM D56-22. Within this range, the trans-1,2-dichloroethylene can comprise greater than or equal to 0.01 wt. % and less than or equal to 40, 30, 20, 10, or 5, 3, 2, 1, 0.5, or 0.25 wt. % of at least one of (E)-1-chloro-2,3,3-trifluoroprop-1-ene or (Z)-1-chloro-2,3,3-trifluoroprop-1-ene.

Thus, in some embodiments, a method for preparing a nonflammable solvent composition from trans-1,2-dichloroethylene comprises mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the solvent composition, measured according to any one or more of ASTM D92-18, ASTM D1310-14, or ASTM D56-22. In another embodiment, the method of preparing a nonflammable solvent composition from trans-1,2-dichloroethylene comprises mixing the trans-1,2-dichloroethylene with about 0.01 wt. % to less than 3 wt. % of the at least one of (E)-1-chloro-2,3,3-trifluoroprop-1-ene or (Z)-1-chloro-2,3,3-trifluoroprop-1-ene to form the nonflammable solvent composition. In another embodiment, t-DCE can be mixed with perfluoro(2-methyl-3-pentanone) to form a nonflammable solvent composition. Any order of addition of the components can be used. When desired, one or more other components or additives, such as those discussed herein, can be added to the nonflammable solvent mixtures comprising t-DCE and at least one of (E)-1-chloro-2,3,3-trifluoroprop-1-ene or (Z)-1-chloro-2,3,3-trifluoroprop-1-ene.

The nonflammable solvent composition may further contain at least one additive, for example at least one cosolvent, surfactant, lubricious additive, inhibitor, acid acceptor, metal passivator, or antioxidant. The amount of the additive can vary widely depending on the particular additive and/or application in which the nonflammable solvent composition is being used, but is readily apparent to those skilled in the art. The total amount of additives may be in an amount of up to about 40 wt. %, about 20 wt. %, about 10 wt. %, or about 5 wt. % based on the total weight of the nonflammable solvent composition. More specifically, these additives may be present in an amount of about 0.01 wt. % to about 15 wt. %, about 0.1 wt. % to about 7 wt. %, or about 0.1 wt. % to about 2 wt. % based on a total weight of the nonflammable solvent composition.

In some embodiments, cosolvents may be added to the nonflammable solvent composition to improve the solubility of contaminants such as grease, soil, or water. The amount of cosolvent should not reduce the cleaning power or alter the azeotropic behavior of the nonflammable solvent composition if it is an azeotrope or azeotrope-like composition. Useful cosolvents include, for example, hydrofluorocarbons (HFCs), hydrocarbons, hydrochlorocarbons (HCCs), or water. Non-limiting examples of suitable co-solvents include carbon dioxide, 1,1-difluoroethane, 1-hydropentadecafluoroheptane, 1,1,1,2-tetrafluoroethane, 1,1,1,3,3-pentafluoropropane, 2-chloropropane, water, saturated perfluorocarbons (e.g. perfluoropentane, perfluorohexane, perfluoro(N-methylmorpholine)) and combinations thereof. In some embodiments, the nonflammable solvent composition further comprises hydrofluoric acid (HF).

The nonflammable solvent composition can further comprise at least one surfactant. The at least one surfactant can improve the dispersibility or the solubility of target contaminants, such as water or soil. The surfactant can also facilitate the dewatering and drying of substrates. The surfactant can be a nonionic surfactant, an anionic surfactant, a cationic surfactant, or a combination thereof. Non-limiting examples of suitable surfactants include ethoxylates and propoxylates, alkylphenol ethoxylates (APEOs), siloxanes, alkyl phosphate amine salts (such as a 1:1 salt of 2-ethylhexyl amine and isooctyl phosphate), ethoxylated alcohols, ethoxylated propoxylated alcohols, ethoxylated mercaptans, quaternary ammonium salts of alkyl phosphates (with fluoroalkyl groups on either the ammonium or phosphate groups), and mono- or di-alkyl phosphates of fluorinated amines.

The amount of surfactant can vary widely depending on the particular application for which the nonflammable solvent composition is being used. For example, the amount of surfactant can be less than or equal to about 1 wt. %, based on the total weight of the nonflammable solvent composition. In other embodiments, larger amounts of surfactant can be used, for example when after treatment with the nonflammable solvent composition, the substrate being dried is thereafter treated with nonflammable solvent composition having either no or minimal surfactant. For example, the surfactant amount can be about 0.1 to about 25 wt. %, about 0.5 to about 15 wt. %, or about 1 to about 10 wt. % based on the total weight of the nonflammable solvent composition.

In some embodiments, small amounts of at least one fluorocarbon are added to the nonflammable solvent composition. For example, small amounts of one or more fluorocarbons may be added to the binary composition of t-DCE and (E)-1-chloro-2,3,3-trifluoroprop-1-ene or (Z)-1-chloro-2,3,3-trifluoroprop-1-ene TFPE, or may be added to the ternary composition of t-DCE, (E)-1-chloro-2,3,3-trifluoroprop-1-ene and (Z)-1-chloro-2,3,3-trifluoroprop-1-ene, or to the quaternary composition of t-DCE, (E)-1-chloro-2,3,3-trifluoroprop-1-ene, (Z)-1-chloro-2,3,3-trifluoroprop-1-ene, and one or more oxygenated solvents. In embodiments where the composition is an azeotrope or azeotrope-like composition, the fluorocarbon is added in an amount such that the azeotropic behavior is not disturbed. The fluorocarbon can be, for example, heptafluorocyclopentane, perfluoro(2-methyl-2-pentene), (E,Z)-perfluoro (4-methyl-2-pentene), 1,1,1,4,4,5,5,5-octafluoro-2-pentene, perfluorobutyl methyl ether, perfluorobutyl ethyl ether, perfluoroisopropylmethyl ether, perfluoroethyl isopropyl ketone, (E)-1,1,1-trifluoro-3-chloro-2-propene, 1,1,1,3,3-pentafluorobutane, 1,1,2,2-tetrafluoroethyl 2,2.2-trifluoroethyl ether. The amount of the at least one fluorocarbon can be about 0.01 to about 5 wt. %, about 0.1 to about 2.5 wt. %, or about 0.5 to about 1 wt. %, based on the total weight of the nonflammable solvent composition.

Nonflammable solvent compositions modified with the at least one fluorocarbon may, in some embodiments have reduced flammability relative to nonflammable solvent compositions without the at least one fluorocarbon. For example, the addition of amounts of the at least one fluorocarbon as low as about 0.6 to about 1.5 wt. % can result in compositions that do not exhibit a measurable flash point in closed cup flash point testing.

In some embodiments, small amounts of lubricious additives may be present to enhance the lubricating properties of the nonflammable solvent composition. Examples of suitable lubricious additives include mineral oils, fatty esters, highly halogenated oils such as chlorotrifluoroethylene-containing polymers, and alkylene oxide polymers.

In some embodiments, antistatic additives may be present in the nonflammable solvent composition. Boiling and general circulation of dewatering and compositions in conventional drying and cleaning equipment can create static charge, particularly in the latter stages of a drying process when most of the water present has been removed from a substrate. Static charge collects on non-conductive surfaces of the substrate and prevents the release of water from the surface. Therefore, residual water dries in place resulting in undesirable spots and stains on the substrate. Static charge remaining on substrates can also result in impurities from the cleaning process being deposited on the surface of a substrate, for example lint from the air, which results in unacceptable cleaning performance. Thus, in one embodiment, the nonflammable solvent composition is a dewatering composition containing an antistatic additive, and is effective in dewatering, drying, and rinse steps of a method to dewater or dry a substrate.

Suitable antistatic additives include, for example, polar solvents that are soluble in the nonflammable solvent composition, and that result in an increase in the conductivity of the nonflammable solvent composition and dissipation of static charge from a substrate. In some embodiments, the antistatic additive has a boiling point near that of the nonflammable solvent composition and has minimal to no solubility in water, for example less than about 0.5 wt. %. In one embodiment, the solubility of the antistatic additive is at least 0.5 wt. % in the nonflammable solvent composition. The antistatic additive can be, for example, nitromethane, nitroethane, acetonitrile, or a combination thereof.

In some embodiments, the nonflammable solvent composition is sprayed onto the surface as an aerosol. In these embodiments, the nonflammable solvent composition is combined with a propellant to create an aerosol. Thus, in some embodiments, an aerosol cleaner comprises the nonflammable solvent composition and an aerosol propellant. The aerosol propellant assists in delivering the nonflammable solvent composition to a surface to be cleaned from a storage container. Representative aerosol propellants include air, nitrogen, carbon dioxide, 2,3,3,3-tetrafluoropropene (HFO-1234yf), trans-1,3,3,3-tetrafluoropropene (HFO-1234ze), 1,2,3,3,3-pentafluoropropene (HFO-1225ye), difluoromethane (CF₂H₂, HFC-32), trifluoromethane (CF₃H, HFC-23), difluoroethane (CHF₂CH₃, HFC-152a), trifluoroethane (CH₃CF_{3, HFC-}143a; or CHF₂CH₂F, HFC-143), tetrafluoroethane (CF₃CH₂F, HFC-134a; or CF₂HCF₂H, HFC-134), pentafluoroethane (CF₃CF₂H, HFC-125), and hydrocarbons, such as propane, butanes, pentanes, dimethyl ether, and combinations thereof. In some embodiments of the aerosol cleaner, the propellant comprises at least one of carbon dioxide, ethane, a haloalkene liquefied gas, or a haloalkane liquefied gas. In some embodiments of the aerosol cleaner, the haloalkane liquified gas comprises tetrafluoroethane. The tetrafluoroethane can be, for example, 1,1,1,2-tetrafluoroethane (R-134a). In other embodiments of the aerosol cleaner, the haloalkene liquefied gas comprises trans-1,3,3,3-tetrafluoroprop-1-ene. In some embodiments of the aerosol cleaner, the propellant comprises carbon dioxide or carbon dioxide in combination with at least one of a hydrofluorocarbon (HFC), hydrofluoroolefin (HFO), or hydrochlorofluoroolefin (HCFO) liquefied gas. The amount of aerosol propellant in the aerosol cleaner can be about 1 to about 50 wt. %, or about 3 to about 50 wt. % based on the total weight of the aerosol cleaner. In some embodiments, the aerosol cleaner can comprise about 50 wt. % to about 99 wt. % of the nonflammable solvent composition; and about 1 wt. % to about 50 wt. % of the aerosol propellant comprising at least one of carbon dioxide, ethane, a haloalkene liquefied gas, or a haloalkane liquefied gas. In other embodiments, the amount of aerosol propellant can be up to about 25 wt. % based on the total weight of the aerosol cleaner. The aerosol cleaner can be inserted into an aerosol container capable of spraying the aerosol cleaner. The aerosol cleaner can also be mixed with boron nitride powder and/or other compatible powder additives, such as metal powders, to create an aerosol mixture. The aerosol spray container, such as an aerosol can, can be configured to spray the aerosol onto a surface of an article.

The nonflammable solvent composition is ideally suited for cleaning, dewatering, or drying contaminated surfaces. Cleaning additives can enhance the cleaning efficacy of the nonflammable solvent composition. Thus, a cleaning composition can comprise the nonflammable solvent composition and at least one cleaning additive, wherein the cleaning composition dissolves a greater range of contaminants or materials comprising one or more of polar substances, ionic substances, salts, or water-soluble compounds than the solvent composition alone. The cleaning additive can be, for example, a cosolvent, a surfactant, or a combination of a cosolvent and surfactant. Suitable cosolvents and surfactants are discussed above. For example, the cleaning additive can comprise at least one of an organic solvent or an anionic, cationic, or nonionic surfactant, or a fluorosurfactant. Examples of surfactants are provided above. The organic solvent can be any solvent disclosed in U.S. Pat. No. 10,934,507 B2, to Shellef, incorporated by reference in its entirety herein. The organic solvent be one or more hydrocarbons and/or oxygenated solvents. For example, the organic solvent can be one or more C₁ to C₅₀ aliphatic or aromatic hydrocarbons, optionally containing a heteroatom. The organic compound can be one or more C₁ to C₂₅, C₁ to C₂₀, C₁ to C₁₅, or C₁ to C₁₀ hydrocarbons, optionally containing a heteroatom. The heteroatom can be, for example, one or more of oxygen, nitrogen, sulfur, or phosphorus. In some embodiments, the at least one organic compound contains oxygen and/or nitrogen.

In some embodiments, the at least one organic solvent is an alkane, cycloalkane, arene, alkene, cycloalkane, alcohol, ketone, aldehyde, ether, ester, carboxylic acid, nitrile, nitro compound, heterocyclic compound, and combinations thereof. For example, the organic compound can be one or more of a C₁ to C₂₅ alkane or cycloalkane, a C₁ to C₂₅ arene, a C₁ to C₂₅ alkene or cycloalkane, a C₁ to C₂₂ alcohol, a C₁ to C₂₂ ketone, a C₁ to C₂₂ aldehyde, a C₁ to C₂₂ ether, a C₁ to C₂₂ ester, a C₁ to C₂₂ carboxylic acid, a C₁ to C₁₀ nitrite, a C₁ to C₁₀ nitro compound, a C₁ to C₁₀ heterocyclic compound, and combinations thereof. The organic solvent can also be one or more of a C₁ to C₁₅ alkane or cycloalkane, a C₁ to C₁₅ arene, a C₁ to C₁₂ alkene, a C₁ to C₁₂ alcohol, a C₁ to C₁₂ ketone, a C₁ to C₁₂ aldehyde, a C₁ to C₁₂ ether, a C₁ to C₁₂ ester, a C₁ to C₁₂ carboxylic acid, a C₁ to C₅ nitrile, a C₁ to C₅ nitro compound, and a C₁ to C₇ heterocyclic compound.

Specific examples of the organic compound include methanol, ethanol, n-propanol, iso-propanol, n-butanol, iso-butanol, t-butanol, methyl acetate, ethyl acetate, t-butyl acetate, dimethoxy methane, dimethoxy ethane, dimethoxy propane, acetone, methyl ethyl ketone, methyl isobutyl ketone, nitromethane, dimethylcarbonate, acetic acid, acetonitrile, diethyl ether, ethylene glycol, diethylene glycol, diethylene glycol dimethyl ether, glycerin, methyl t-butyl ether, dimethyl-formamide, pyridine, dimethyl sulfoxide, butyleneoxide, furan, tetrahydrofuran, dioxane, toluene, xylene, pentane, hexane, cyclohexane, heptane, octane, pentane, hexene, cyclohexane, heptane, benzene, and combinations thereof. Any other suitable organic compound can be used in the nonflammable solvent composition disclosed herein. Even though t-DCE is flammable and is contained in the composition in a large amount, and the organic solvent(s) may also be flammable, the resulting cleaning composition can be nonflammable, having no fire point fire point over a temperature range of 10° C. to the boiling point of the solvent composition, measured according to any one or more of ASTM D92-18, ASTM D1310-14, or ASTM D56-22. Advantageously, the combination of nonflammable solvent composition with the cleaning additive allows the cleaning additive to be used in a wider range of applications than in other cleaning compositions not comprising the nonflammable solvent composition. This is due to the increased flash point, lower viscosity, and reduced health and safety risks associated with the nonflammable solvent composition.

The nonflammable solvent composition is ideally suited for cleaning surfaces of articles, i.e. to dissolve, displace, or disperse at least one contaminant from the surface. Thus, a method of cleaning a surface of an article comprises applying the nonflammable solvent composition to the surface of the article. The nonflammable solvent composition can then be removed from the surface. The method of cleaning reduces the level of contaminants on the surface. Therefore, after contacting the surface with the nonflammable solvent composition, the surface is substantially free of contaminants and is also substantially free of residue from the nonflammable solvent composition.

The nonflammable solvent composition disclosed herein may be used to clean the surface of any device, article of manufacture, product, part, component, substrate, or any portion thereof that may be subject to contamination by unwanted materials. For example, the solvent composition may be used to clean the surface of machine parts, tools, component assemblies, complex metal parts, implantable prosthetic devices, electrical and electronic components, switches, circuits, boards, printed circuit boards, semiconductor chips, magnetic media, disk drive heads, avionics, connectors, relays and contacts, solenoids, motor and motor windings, circuit breakers, circuit breaker panels, transformers, electrical and data communication connectors and switching devices, electronic controls, timers, cable assemblies, splices and terminations, hydraulic and pneumatic equipment, optical equipment, fiber optics, metal or metal oxide products, glass products, plastics, elastomers, photographic and movie film, molds for casting plastics, surfaces being prepared for painting, fabrics, animal hides, ceramics, stone or stone-like materials such as concrete, wood, natural fibers, synthetic fibers, PVC pipes, optical lenses, polymeric substrates, and the like, and any portion thereof. The surface may be of an article connected to a power source, such as an AC power source, a battery, or the like.

The term, “contaminant” is used in a broad sense to designate any unwanted material or substance present on the article, even if the material or substance was placed on the article intentionally. For example, circuit boards, commonly used in electronic appliances, such as televisions and computers, are often contaminated with solder flux in the assembly process. Solder flux is a grease-like substance that is either applied to the surface of the board before soldering, or is contained in the core of the solder itself, in order to help the solder retain heat and spread onto a surface. This sticky flux residue must then be removed from the surface of the circuit board. Non-limiting examples of “contaminant” include flux (e.g., solder flux), grease, wax, oil, polymer, lubricant, dirt, lint, dust, particulate matter, corrosive materials, oxidation products, residue, and the like. For example, the composition may be used to remove relatively heavy motor oil and lighter weight oils, such as machine oils or other light-weight lubricants, such as silicone or Teflon® polytetrafluoroethylene (PTFE).

The composition may be used to clean electronic or electrical devices or components, such as integrated circuits or silicon chips. It is necessary to clean silicon chips to remove any traces of contamination or foreign matter, as these delicate parts must be absolutely clean to perform properly.

The contacting of the article with the composition may be performed in a variety of ways. The contacting can be performed by wet cleaning (nonflammable solvent composition in the liquid phase) or by vapor degreasing (nonflammable solvent composition in the vapor phase). The wet cleaning can be performed on any of the afore-mentioned articles, including electronic or electrical components or devices.

The contacting step can be performed in any suitable apparatus or vessel, including, for example, in a reaction vessel, sump, vat, dip tank, autoclave, vapor degreaser, spray booth, or the like, and may be conducted while the vessel is open or closed to the atmosphere. Alternatively, the contacting need not be performed in an apparatus or vessel at all. The wet cleaning can be performed via a parts washer, any batch loaded, non-boiling degreaser, and be applied as sprays, aerosols, and the like. For example, the wet cleaning can involve spraying the nonflammable solvent composition onto the article, flushing the article with the nonflammable solvent composition, wiping the article with an absorbent medium containing the nonflammable solvent composition to remove contaminants from the surface, or immersing the article in the nonflammable solvent composition.

In some embodiments, the nonflammable solvent composition is applied to the surface of the article by spraying. The nonflammable solvent composition may be sprayed in the form of a liquid or an aerosol. For example, a jet stream of the nonflammable solvent composition may be sprayed onto the article. The nonflammable solvent composition may be sprayed onto the article from a trigger bottle or pump sprayer. The surface of the article can be brushed or wiped before, during, or after spraying the nonflammable solvent composition onto the surface of the article. For example, the article may be brushed or wiped to assist in cleaning, particularly if the article contains an excessive amount of contaminants. Such brush or wiping can be effective in enhancing penetration of the contaminants by the nonflammable solvent composition. In some embodiments, the nonflammable solvent composition is an aerosol cleaner that can be sprayed onto a surface of a substrate as an aerosol. Aerosol cleaners are discussed above.

In some embodiments, the nonflammable solvent composition is applied to the surface of the article by immersion of the article in the nonflammable solvent composition. Wet cleaning can include fully or partially immersing or soaking an article in the nonflammable solvent composition with or without agitation. For example, the wet cleaning can be performed by contacting the article in a sump, vat, dip tank, or the like containing the nonflammable solvent composition. The article can also be subjected to ultrasonic agitation or contacted with a jet stream of the nonflammable solvent composition. In some embodiments, the nonflammable solvent composition is sprayed onto an article prior to degreasing, such as vapor degreasing.

Ultrasonics can be used in conjunction with wet cleaning for removing at least one of water or water-soluble contaminants from, for example, deep recesses or inaccessible areas of an article or for dislodging contaminants that are strongly adhered to a surface of the article.

Wet cleaning can include applying the nonflammable solvent composition to a surface of an article with an absorbent medium. The absorbent medium can be, for example, a cloth, swab, paper, or brush saturated with the nonflammable solvent composition. A surface of an article can be wiped, rubbed, or brushed with the absorbent medium. For example, when the absorbent medium is a cloth, the article can be wiped with the cloth to wet clean the article. The method of cleaning can comprise rubbing an absorbent or abrasive medium, for example a brush, wipe, cloth, scouring pad, or particles insoluble in the nonflammable solvent composition, against the surface of the article to dissolve or mechanically dislodge a contaminant.

The contacting temperature can vary widely depending on the boiling point of the nonflammable solvent composition, as well as the specific application. For example, the cleaning can be done at room temperature or at an elevated temperature, e.g. up to and including the boiling point of the nonflammable solvent composition. In some embodiments, the boiling point of the nonflammable solvent composition can be, for example, about 35 to about 65° C., about 40 to about 60° C., or about 45 to about 55° C., at atmospheric pressure. In these embodiments, the contacting temperature can likewise be for example, about 35 to about 65° C., about 40 to about 60° C., or about 45 to about 55° C. at atmospheric pressure.

As mentioned above, the method of contacting can be dipping or immersing the article in a bath of the nonflammable cleaning composition. The cleaning methods include immersing the article to be cleaned in the nonflammable solvent composition at an elevated contacting temperature as described above, for example at about the boiling point of the nonflammable solvent composition. This step may remove a substantial amount of a target contaminant from an article or remove a major portion of the target contaminant. In some embodiments, this step is followed by immersing the article in freshly distilled nonflammable solvent composition at a temperature below the temperature of the nonflammable solvent composition in the preceding immersion step. The freshly distilled nonflammable solvent composition can be at or about ambient or room temperature.

For contaminants resistant to removal, such as grease, in which elevated temperatures are necessary to improve the cleaning action of the nonflammable solvent composition, or for large volume assembly line operations in which the cleaning of metal parts and assemblies must be done efficiently, the contacting can be done by vapor degreasing. In its simplest form, vapor degreasing involves exposing an article to be cleaned at room temperature to the vapors of a boiling nonflammable solvent composition. The clean, distilled vapors condense on the article to wash away contaminants. In this way, final evaporation of the nonflammable solvent composition from the article leaves substantially no contaminant residue on the article. Vapor degreasing can be done in open or closed vapor degreasers. Numerous varieties and types of vapor degreasers are adaptable for use in connection with the present nonflammable solvent composition. The vapor degreaser can include a boiling sump or reservoir for containing the nonflammable solvent composition, a clean sump for containing the distilled cleaning composition, a water separator, and other ancillary equipment.

The surface of the article can be relatively cold compared to the relatively hot vapor to facilitate condensation of the nonflammable solvent composition onto the article. The condensed vapors can then dissolve or entrain one or more contaminants on the surface of the article to be cleaned. The contaminated nonflammable solvent composition (i.e., the condensed nonflammable solvent composition containing the dissolved contaminants) drains into a reservoir, e.g. by falling from the article into the reservoir under the influence of gravity. The reservoir can be the same reservoir containing the nonflammable solvent composition that is heated to vaporize it. The nonflammable solvent composition can be vaporized continuously to form a vapor blanket comprising the nonflammable solvent composition. Because only the nonflammable solvent composition is vaporized—not the contaminants—the contaminants remain in the reservoir, for example in the form of a sludge. In this way the article is continuously flushed with non-contaminated, or virgin, nonflammable solvent composition.

The contacting of the vapor with an article to be cleaned can result in a scrubbing action as the vapor condenses on the article. The article can be maintained in contact with the vapor for a period of time sufficient to raise the temperature of the article to about the temperature of the vapor. At this point, condensation substantially ceases and the article appears dry. The article can then be removed from the degreaser. The time required to cause cessation of vapor condensation varies depending upon numerous factors, including the specific nonflammable solvent composition employed, the temperature of the vapor, the weight of the article, its specific heat, and the type(s) of contaminant(s) to be removed.

Vapor degreasing can advantageously be used to penetrate and clean any holes, cracks, or crevices of the article, from which it would be difficult to remove contaminants from by other methods, for example by wiping, rubbing, or brushing with an absorbent medium containing the nonflammable solvent composition.

Another type of vapor degreasing is referred to as vapor-spray cycle degreasing. In vapor-spray cycle degreasing, the article to be cleansed is first placed in a vapor zone, as is done in the above-described vapor degreasing process. A portion of the vapor is condensed by use of cooling coils and fills a liquid solvent reservoir. Warm liquid solvent is pumped through a spray nozzle which sprays it directly onto the part to be degreased, thus washing off contaminants and cooling the article.

In some embodiments, the vapor phase degreasing may be liquid-vapor cycle degreasing. In liquid-vapor cycle degreasing, a first compartment contains a refluxing solvent and a second compartment contains a somewhat cooler solvent condensate, which is referred to as the rinse sump. A vapor zone is maintained over the refluxing solvent. In this type of degreasing operation, the article to be cleaned is first suspended in the vapor zone until condensation of vapor on the article ceases. Next, the article is lowered into the refluxing solvent in the first compartment. After a suitable period of time, the article is removed to the rinse sump. Finally, the parts are again placed in the vapor zone until dry. This type of degreasing is particularly useful for heavily soiled articles or for cleaning a basket or container of small parts that are nested together.

In some embodiments, the vapor phase degreasing is in conjunction with ultrasonic degreasing. Ultrasonic degreasing can be useful for cleaning critical parts and typically uses a transducer that is mounted submerged at the base of a clean sump of the solvent tank and operates above 20 kHz. The transducer alternately compresses and expands the solvent composition, thereby forming small bubbles that, in turn, cavitate or collapse on the surface of a submerged article. This cavitation phenomenon disrupts the adhering contaminants, thereby cleaning the article.

Because vapor degreasing operations generally involve the use of a heat source in relatively close proximity to the degreasing solvents in both liquid and vapor states, it is highly beneficial to use a solvent composition that remains nonflammable through all parts of the degreasing process/apparatus in order to minimize or reduce the danger of fire or explosion. Similarly, it is highly recommended to use a nonflammable solvent composition for cleaning electronic or electrical components or devices to minimize or reduce the danger of the component or device catching fire.

In most embodiments, the solvent compositions disclosed herein are nonflammable despite containing a significant amount of t-DCE, which is flammable. The methods of cleaning, of an article using the nonflammable solvent composition, particularly vapor degreasing, is highly advantageous at least because it reduces the risk of fire or an explosion. Another advantage of the present methods of cleaning that use a nonflammable solvent composition disclosed herein is that precautions against the hazard of flammability or explosion need not be taken. Further, there is no need to label storage tanks containing the nonflammable solvent composition with signs or warnings against those risks. The result is lower risk to every person involved in the lifecycle of the invention, such as transporters, handlers, storage facilities, distributors, users, waste management, and the general public.

Azeotrope or azeotrope-like compositions are especially advantageous for use in a vapor degreasing because they do not fractionate upon boiling. In other words, both the distillate and residual non-distilled solvent have substantially the same composition. Therefore, the composition is not shifted into a flammable range during vapor degreasing. Furthermore, even after partial distillation, both the distillate and the non-distilled residue retain the same physical properties, for example, its ability to degrease and dewater articles and solubilize contaminants. This is also advantageous because in vapor degreasing, redistilled solvent is generated for a final rinse. Thus, a vapor degreasing system acts as a still to regenerate virgin nonflammable solvent composition free of non-volatile contaminants. Unless the nonflammable solvent composition exhibits a constant boiling point, i.e. is at least azeotrope-like, fractionation can occur resulting in a change in the nonflammable solvent composition which can adversely affect the cleaning efficacy and safety of vapor degreasing with a nonflammable solvent composition.

After contact with the article to be cleaned, the nonflammable solvent composition containing dissolved contaminants can be removed from the surface of the article by evaporation, draining, wiping, or brushing the nonflammable solvent composition off the surface. For example, the nonflammable solvent composition containing dissolved contaminants can be removed from the surface of the article by wiping it away a cloth or other porous material, or by letting the nonflammable solvent composition run off into a pan or other collection device. In some embodiments, the nonflammable solvent composition is removed from the article by evaporation, for example. The present nonflammable solvent composition can evaporate quickly. In some embodiments, the nonflammable solvent composition evaporates at ambient or room temperature. Alternatively, the article can be heated to facilitate evaporation. The article can also be contacted with a jet stream of warm air to facilitate evaporation.

As a result of the methods of cleaning disclosed herein, one or more contaminants are removed from the article, for example, by being dissolved by the nonflammable solvent composition. The method of cleaning can be, for example, vapor degreasing, vapor-spray cycle degreasing, liquid-vapor cycle degreasing, or ultrasonic degreasing. Use of the present nonflammable solvent composition in any of these degreasing methods is advantageous because substantially no dissolved residue in the nonflammable solvent composition remains on the surface after cleaning. Not only might residue interfere with the performance of an article, for example, an electrical or electronic component, but it could also damage the article. The present nonflammable solvent compositions advantageously leave substantially no residue, while simultaneously being good solvents for contaminants otherwise resistant to removal.

The nonflammable solvent composition is also useful as a drycleaning solvent. Thus, a drycleaning method comprises, for example, contacting a fabric or fiber with the nonflammable solvent composition in a drycleaning machine to clean the fabric or fiber. The fabric or fiber can be, for example, a garment, bedding, linens, a furniture covering, rug, a wall covering, drapery, napkin, or tablecloth. The fabric or fiber can be, for example, cotton, wool, silk, rayon, polyester, nylon, acetates, polyolefins, acrylics, spandex, or blends thereof. After contacting the fabric or fiber with the nonflammable solvent composition, the fabric or fiber can be heated to remove any residual nonflammable solvent composition from the fabric or fiber. In addition to the nonflammable solvent composition, the drycleaning solvent composition can further comprise a detergent, anti-static agent, surfactant, fabric softener, brightener, disinfectant, anti-redeposition agent, fragrance, or a combination thereof.

The nonflammable solvent composition can be used as a blowing agent for the preparation of foams. Thus, in some embodiments, A method of preparing a foam comprises preparing a foam composition comprising the nonflammable solvent composition of claim 1 as a blowing agent. Blowing agent compositions are used to prepare foams. For example, a method of preparing a foam comprises providing a blowing agent composition comprising the nonflammable solvent composition, directly or indirectly adding the blowing agent composition to a foamable composition, and foaming and curing the foamable composition under conditions effective to form a foam or cellular structure (for example temperature and time), as is well known in the art. For example, a blowing agent composition comprising the nonflammable solvent composition can be vaporized in the presence of a foamable composition to form a foam which is cured under the same conditions. Other materials, such as catalysts, surfactants, flame retardants, colorants, or other additives can be present in the foamable composition to achieve desired foam properties.

The nonflammable solvent composition can be used in a variety of other applications, including dewatering, refrigeration flushing, oxygen system cleaning, foam blowing, paints, adhesives, lubricants, drycleaning, and methods for depositing a material onto a substrate, for example for depositing silicone fluids onto hypodermic needles, for depositing lubricating oils in minute and inaccessible places, and for depositing paints, varnishes, and glues onto substrates.

The nonflammable solvent composition can be used for dewatering or drying a substrate. Thus, in some embodiments, a method for dewatering or drying a substrate includes contacting a substrate with the nonflammable solvent composition, thereby dewatering the substrate, and recovering the dewatered substrate from the nonflammable solvent composition. The dewatering or drying is effective in displacing water from a broad range of substrates including, for example, metals, such as tungsten, copper, gold, beryllium, stainless steel, aluminum alloys, brass and the like; from glasses and ceramic surfaces, such as glass, borosilicate glass, alumina, silica such as silicon wafers used in electronic circuits, amorphous silica and alumina, and the like; and from plastics.

Methods of contacting the substrate with the nonflammable solvent composition are not limited and can vary widely. For example, the substrate can be immersed in the nonflammable solvent composition, or the substrate can be sprayed with the nonflammable solvent composition using conventional equipment. Complete immersion of the substrate is sometimes preferred as it generally ensures contact between the nonflammable solvent composition and all exposed surfaces of the substrate. However, any method which provides complete or nearly complete contact between the nonflammable solvent composition and the substrate can be used.

In some embodiments of the dewatering process, a contacting time is from about 1 second to about 5 minutes. Within this range, the contacting time can be from about 15 seconds to about 4 minutes. Contacting temperatures can also vary widely depending on the boiling point of the nonflammable solvent composition. In general, the contacting temperature is equal to or less than the normal boiling point of the nonflammable solvent composition.

The nonflammable solvent composition can also be used to deposit a material onto a substrate, i.e. as a carrier solvent for a material. Applications include, for example, paints, coatings, adhesives, lubricants, penetrants, and surface protectants. In particular, the nonflammable solvent composition is advantageous in solvent-borne coatings in which a material is dissolved or dispersed in the nonflammable solvent composition, applied to a surface of a substrate as a solution, and then deposited on the surface of the substrate upon evaporation of the nonflammable solvent composition. Nonflammable azeotrope or azeotrope-like solvent compositions are particularly desirable for use in solvent-borne coatings, because solubility parameters of the nonflammable solvent composition remain relatively constant as the azeotrope or azeotrope-like composition evaporates. Thus, in some embodiments, a coating composition comprises the nonflammable solvent composition disclosed herein and a material dispersed in the nonflammable solvent composition.

The material deposited on the surface of a substrate can comprise at least one of an oil, wax, lubricant, silicone fluid, pesticide, insecticide, fungicide, synthetic polymer, biopolymer, or coating binder. A method of coating a substrate with the material comprises: dissolving or dispersing the material in the nonflammable solvent composition to form a coating composition; applying the coating composition to the substrate to form a continuous coating composition film disposed on the substrate; and evaporating the nonflammable solvent composition from the coating composition film to form a continuous film of the material disposed on the substrate. The material can be dispersed in the nonflammable solvent in the form of, for example, a solution, a colloid, a sol, an emulsion, or a suspension.

The coating composition can be applied to the substrate by at least one of dipping, brushing, wiping, spraying, vapor deposition, or immersion of the substrate in the coating composition. The nonflammable solvent composition can be evaporated from the coating composition by evaporation under ambient conditions, or by heating the coating composition. In this way, a continuous film of the material is disposed on the substrate. In some embodiments, the nonflammable solvent composition is evaporated from the coating composition film by heating.

In another embodiment, the nonflammable solvent composition can be used to remove a coating film from a substrate. In this method, the substrate is contacted with the nonflammable solvent composition to dissolve the coating film, and then the solution of the coating film dissolved in the nonflammable solvent composition is removed from the substrate. For example, the coating film can be a paint film, and the nonflammable solvent composition can be used to strip the paint film from a substrate, i.e. it is a paint remover.

In some embodiments, a mold release composition comprises the nonflammable solvent composition of claim 1 and at least one mold release additive dispersed in the nonflammable solvent composition. Mold release additives provide a barrier between a molding surface and a substrate, and serve to facilitate separation of the substrate, i.e. a part, cured in the mold from the mold. Without such a barrier, the substrate would become fused to the mold surface, resulting in difficult clean-up and loss in production efficiency. The mold release additive can be, for example, a wax, a fatty ester, a silicone, or a metallic soap.

The nonflammable solvent composition can be used in lubricant compositions. Thus in some embodiments, a lubricant composition comprises the nonflammable solvent composition and optionally a lubricious additive. The lubricant composition can be used in tooling of work parts composed of, for example metal, cement, engineering thermoplastics, or composites. The lubricious additive is defined herein as an additive that modifies the coefficient of friction between a work piece and a tool. Lubricants for tooling, also known as working fluids, lubricate machining surfaces, thus providing smooth and substantially residue-free machined work part surfaces. The working fluid also serves to cool the machining environment, for example, the surface interface between a work piece and tool, by, for example, removing heat therefrom. The working fluid also serves to carry away particulate matter removed from the work part by tooling.

The working fluid is formulated so that the cutting and forming processes are lubricated to reduce friction, reduce heat build-up in the tool and work piece, and/or prevent material transfer from the work piece to the tool. In some embodiments, the working fluid fully wets the tool. In some embodiments, the nonflammable solvent composition in the working fluid evaporates from the tool and work part, leaving behind a thin film of the lubricious additive on the surfaces of the tool and work part, thereby serving to reduce friction and heat build-up on the surfaces of the tool and work part, and/or preventing material transfer from the work part to the tool. The lubricious additive can be selected such that it is sufficiently high in boiling point to lubricate the tooling process without evaporating prematurely and sufficiently low in boiling point to fully evaporate from the tooling process so that little or no residue remains. Lubricious additives for tooling can be, for example, esters of C₈ to C₁₄ fatty acids, alkylene glycol ethers, hydrocarbon distillates, or esters of lactic acid.

The nonflammable solvent composition can also be used as a heat-transfer fluid for heat-transfer processes in which the heart-transfer fluid can transfer thermal energy (e.g., heat). Thus, a method for transferring heat comprises circulating a heat transfer composition comprising the nonflammable solvent composition through a temperature gradient, wherein the heat transfer composition transfers heat from a heat source to a heat sink. In a method for transferring heat, the heat is transferred by condensing the heat transfer composition and by evaporating the heat transfer composition. The heat transfer can be done in a direct or indirect manner. In direct heat transfer, the heat-transfer fluid conducts heat directly to a heat sink and/or from a heat source through direct contact of the fluid with the heat sink or heat source. Examples of direct heat transfer processes include immersion cooling of electrical components and cooling of an internal combustion engine.

In indirect heat transfer, a heat-transfer fluid conducts heat to heat sink and/or from a heat source without direct contact of the fluid with the heat sink or source. Examples of indirect heat transfer include refrigeration, air conditioning, or heating using heat pumps, which are used in buildings, vehicles, and stationary machinery. In some embodiments, a process for transferring heat comprises employing the nonflammable solvent composition as a secondary loop refrigerant or as a primary loop refrigerant. In these embodiments, a secondary loop refrigerant (i.e., a wide temperature range liquid fluid) provides a means for transferring heat between the heat source and the primary loop refrigerant (i.e., a low temperature-boiling fluid, which absorbs heat by for example expanding to a gas and emits heat by condensing to a liquid, for example by means of a compressor. Examples of equipment in which the nonflammable solvent compositions are useful as heat transfer fluids include centrifugal chillers, household refrigerator/freezers, automotive air conditioners, refrigerated transport vehicles, heat pumps, supermarket food coolers and display cases, and cold storage warehouses.

In indirect heat-transfer processes, lubricious additives can be incorporated in the heat-transfer fluid when moving parts (e.g., pumps and valves) are present to ensure that the moving parts continue to work over long periods of time. Lubricious additives should possess good thermal and hydrolytic stability and should exhibit at least partial solubility in the heat-transfer fluid. Examples of suitable lubricious additives include mineral oils, fatty esters, highly halogenated oils, such as chlorotrifluoroethylene-containing polymers, and synthetic lubricious additives, such as alkylene oxide polymers. The nonflammable solvent compositions can also function as a working fluid in an organic Rankine cycle, useful for example to recover energy from sources such as waste heat from industrial processes, geothermal heat, and solar heat.

The following examples are set forth as representative. These examples are not to be construed as limiting the scope of the invention as these and other equivalent embodiments will be apparent in view of the present disclosure and appended claims.

Mixtures of t-DCE and HFCO-1233yd were prepared in weight ratios of 99:1 to 91:9 of t-DCD to HFCO-1233yd. HFCO-1233yd is a mixture of (Z)- and (E)-1-chloro-2,3,3-trifluoroprop-1-ene in a 90:10 weight ratio. The compositions are listed in Table 1. The boiling points for the solvent compositions of Ex. 1-9 are all in the range of 46 to 48° C.

TABLE 1
Mixtures of t-DCE and HFCO 1233yd

| Example | 1 | 2 | 3 | 4 | 5 | 6 | 7 | 8 | 9 |
|---|---|---|---|---|---|---|---|---|---|
| Com- | 99:1 | 98:2 | 97:3 | 96:4 | 95:5 | 94:6 | 93:7 | 92:8 | 91:9 |
| positionª | | | | | | | | | |

^{a}Weight ratio of t-DCE to HFCO-1233yd.

The solvent compositions of Ex. 1-9 were tested for fire point at the boiling points of the solvent compositions (46 to 48° C.). Flash point is the lowest temperature at which a liquid releases enough vapor to form a flammable mixture with air near its surface. At the flash point, the vapor can ignite momentarily when exposed to an open flame or spark, but it may not sustain combustion. In contrast, the fire point is the lowest temperature at which a volatile combustible substance continues to burn in air after its vapors have been ignited. Unlike the flash point, where ignition is momentary, the fire point indicates the temperature at which combustion is sustained even after the ignition source is removed. For measurement of fire point, the flame must be sustained for at least five seconds under standard testing conditions. This ensures that the liquid produces enough vapor to support continuous combustion. The fire points of the solvent compositions of Ex. 1 to 9 were measured at the boiling points of the solvent compositions according to ASTM D1310-14 (Tag open cup) and ASTM D92-24 (Cleveland Open Cup) The results are summarized in Table 2. Surprisingly, none of the solvent compositions exhibited a fire point at the boiling points of the compositions (46 to 48° C.), including Ex. 1 with a weight ratio of t-DCE to HFCO-1233yd of 99:1.

TABLE 2
Fire Point at the Boiling Point

| Test | | | | | | | | | |
|---|---|---|---|---|---|---|---|---|---|
| Method | Ex. 1 | Ex. 2 | Ex. 3 | Ex. 4 | Ex. 5 | Ex. 6 | Ex. 7 | Ex. 8 | Ex. 9 |
| ASTM | None | None | None | None | None | None | None | None | None |
| D-1310 | | | | | | | | | |
| ASTM | None | None | None | None | None | None | None | None | None |
| D-92 | | | | | | | | | |

The solvent compositions of Ex. 1-9 were tested for flash point over a temperature range of-10° C. to at the boiling points of the solvent compositions (46 to 48° C.) according to both ASTM D56-22 (Tag Closed Cup) and ASTM D3828-16a (Small-scale Closed Cup). The results are summarized in Table 3. Surprisingly, although flash points were observed at −5 to 2° C. for the solvent compositions of Ex. 1-4, composed of 1%, 2%, 3%, and 4% by weight of HFCO-1233yd, respectively, no flash points were observed from 8° C. to the boiling points of 46 to 48° C. for the same solvent compositions.

TABLE 3
Flash Points over the Temperature Range of −10° C. to Boiling
Point, Measured According to ASTM D56 and ASTM D3828

| Temp. | | | | | | | | | |
|---|---|---|---|---|---|---|---|---|---|
| (° C.) | Ex. 1 | Ex. 2 | Ex. 3 | Ex. 4 | Ex. 5 | Ex. 6 | Ex. 7 | Ex. 8 | Ex. 9 |
| −10 | No | No | No | No | No | No | No | No | No |
| −8 | No | No | No | No | No | No | No | No | No |
| −5 | Yes | Yes | Yes | No | No | No | No | No | No |
| −2 | Yes | Yes | Yes | No | No | No | No | No | No |
| 0 | Yes | Yes | Yes | Yes | No | No | No | No | No |
| 2 | Yes | Yes | Yes | Yes | No | No | No | No | No |
| 4 | Yes | No | No | No | No | No | No | No | No |
| 8 | No | No | No | No | No | No | No | No | No |
| 10 | No | No | No | No | No | No | No | No | No |
| 20 | No | No | No | No | No | No | No | No | No |
| 30 | No | No | No | No | No | No | No | No | No |
| 40 | No | No | No | No | No | No | No | No | No |
| Boiling | No | No | No | No | No | No | No | No | No |
| Pointª | | | | | | | | | |

^{a}46 to 48° C.

The present disclosure includes the following numbered embodiments. The embodiments are numbered and refer to other embodiments by number, thus explicitly making logical connections between the embodiments. When a particular feature, structure, or characteristic is described in connection with an embodiment, it is within the ability of one skilled in the art to include such feature, structure, or characteristic in connection with other embodiments whether or not such combination is explicitly described elsewhere in the disclosure.

Embodiment 1. A nonflammable solvent composition comprising, based on the total weight of trans-1,2-dichloroethylene, (E)-1-chloro-2,3,3-trifluoroprop-1-ene, and (Z)-1-chloro-2,3,3-trifluoroprop-1-ene: about 80 wt. % to about 99.99 wt. % of trans-1,2-dichloroethylene; and about 0.01 wt. % to about 20 wt. % of at least one of (E)-1-chloro-2,3,3-trifluoroprop-1-ene or (Z)-1-chloro-2,3,3-trifluoroprop-1-ene; wherein the nonflammable solvent composition has no fire point over a temperature range of 10° C. to the boiling point of the solvent composition, measured according to any one or more of ASTM D92-18, ASTM D1310-14, or ASTM D56-22.

Embodiment 2. The nonflammable solvent composition of Embodiment 1, comprising: greater than 97 wt. % to about 99.99 wt. % of trans-1,2-dichloroethylene; and about 0.01 wt. % to less than 3 wt. % of at least one of (E)-1-chloro-2,3,3-trifluoroprop-1-ene or (Z)-1-chloro-2,3,3-trifluoroprop-1-ene.

Embodiment 3. The nonflammable solvent composition of Embodiment 1, wherein the nonflammable solvent composition is non-azeotropic.

Embodiment 4. A method of preparing a nonflammable solvent composition from trans-1,2-dichloroethylene, comprises mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the solvent composition, measured according to any one or more of ASTM D92-18, ASTM D1310-14, or ASTM D56-22.

Embodiment 5. The method of preparing a nonflammable solvent composition from trans-1,2-dichloroethylene of Embodiment 4, the method comprising mixing the trans-1,2-dichloroethylene with about 0.01 wt. % to less than 3 wt. % of the at least one of (E)-1-chloro-2,3,3-trifluoroprop-1-ene or (Z)-1-chloro-2,3,3-trifluoroprop-1-ene to form the nonflammable solvent composition.

Embodiment 6. A method for increasing the fire point of

trans-1,2-dichloroethylene comprising mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition is nonflammable over a temperature range of 10° C. to the boiling point of the composition, measured according to any one or more of ASTM D-92-18, ASTM D-1310-14, or ASTM D-56-22, and has no fire point at the boiling point of the composition.

Embodiment 7. The method for increasing the fire point of trans-1,2-dichloroethylene of Embodiment 6, comprising mixing the trans-1,2-dichloroethylene with about 0.01 wt. % to less than 3 wt. % of the at least one of (E)-1-chloro-2,3,3-trifluoroprop-1-ene or (Z)-1-chloro-2,3,3-trifluoroprop-1-ene to form the nonflammable solvent composition.

Embodiment 8. The method of Embodiment 7, wherein the nonflammable solvent composition is nonflammable over a temperature range of 10° C. to the boiling point of the composition, and a pressure range of about 0.5 to about 2 atmospheres, measured according to any one or more of ASTM D-92-18, ASTM D-1310-14, or ASTM D-56-22, and has no fire point at the boiling point of the composition.

Embodiment 9. A coating composition comprising the nonflammable solvent composition of Embodiment 1 and a material dissolved or dispersed in the nonflammable solvent composition.

Embodiment 10. A mold release composition comprising the nonflammable solvent composition of Embodiment 1 and at least one mold release additive dispersed in the nonflammable solvent composition.

Embodiment 11. An aerosol cleaner comprising the nonflammable solvent composition of Embodiment 1 and an aerosol propellant.

Embodiment 12. The aerosol cleaner of Embodiment 11, comprising: about 50 to about 99 wt. % of the nonflammable solvent composition; and about 1 to about 50 wt. % of the aerosol propellant comprising at least one of carbon dioxide, ethane, a haloalkene liquefied gas, or a haloalkane liquefied gas.

Embodiment 13. The aerosol cleaner of Embodiment 12, wherein, the aerosol propellant comprises carbon dioxide or carbon dioxide in combination with at least one of a hydrofluorocarbon (HFC), hydrofluoroolefin (HFO), or hydrochlorofluoroolefin (HCFO) liquefied gas.

Embodiment 14. A cleaning composition comprising: the nonflammable solvent composition of Embodiment 1; and at least one cleaning additive; wherein the cleaning composition dissolves a greater range of contaminants or materials comprising one or more of polar substances, ionic substances, salts, or water-soluble compounds than the solvent composition alone.

Embodiment 15. The cleaning composition of Embodiment 14, wherein the cleaning additive comprises at least one of methanol, ethanol, 1-propanol, 2-propanol, hexane, benzene, surfactants, fluorosurfactants, ketones, fluoroketones, silanes, siloxanes, ethoxylates, or methoxylates.

Embodiment 16. A method of preparing a foam, the method comprising preparing a foam composition comprising the nonflammable solvent composition of Embodiment 1 as a blowing agent.

Embodiment 17. A method of cleaning a surface of an article comprising applying the nonflammable solvent composition of Embodiment 1 to the surface of the article.

Embodiment 18. A method of coating a substrate with a material comprising: dissolving or dispersing the material in the nonflammable solvent composition of Embodiment 1 to form a coating composition; applying the coating composition to the substrate to form a continuous coating composition film disposed on the substrate; and evaporating the nonflammable solvent composition from the coating composition film to form a continuous film of the material disposed on the substrate.

Embodiment 19. The method according to Embodiment 18, wherein the material comprises at least one of an oil, wax, lubricant, pesticide, insecticide, fungicide, synthetic polymer, biopolymer, or coating binder.

Embodiment 20. A method for transferring heat comprising circulating a heat transfer composition comprising the nonflammable solvent composition of claim 1 through a temperature gradient, wherein the heat transfer composition transfers heat from a heat source to a heat sink.

It will be appreciated by those skilled in the art that various changes and modifications can be made to the illustrated embodiments without departing from the spirit of the present invention. All such modifications and changes are intended to be within the scope of the present invention except as limited by the scope of the appended claims.

As used herein, “a”, “an”, and “the” refer to both singular and plural referents unless the context clearly dictates otherwise.

The terms “about”, “substantially”, “approximately”, “circa”, and variations thereof are intended to include the degree of error associated with measurement of the particular quantity based upon the equipment available at the time of filing the application. For example, “about” a given value can include a range of ±15% or less, ±10% or less, ±5% or less, or ±1% or less, of the given value. The value to which the modifier “about” refers is itself specifically disclosed herein.

As used herein, comparative terms, such as “high”, “low”, “strong”, “weak”, “more”, “less”, “longer”, “shorter”, and the like, are used for ease of description to describe one element or feature's relationship to another element(s) or feature(s).

The following definitions are to be used for the interpretation of the claims and specification. As used herein, the terms “comprises”, “comprising”, “includes”, “including”, “has”, “having”, “contains”, “containing”, or any other variation thereof, are intended to be non-exclusive. In other words, a composition, process, method, system, or article that comprises a list of elements is not necessarily limited to only those elements but can include other elements not expressly listed or inherent in such composition, process, method, system, or article. Additionally, the terms “exemplary” and “example” are used herein to mean “serving as an example, instance or illustration.” Any embodiment described herein as “exemplary” is not necessarily to be construed as preferred or advantageous over other embodiments. The terms “at least one” and “one or more” are understood to include any integral number greater than or equal to one, i.e. one, two, three, four, etc. The term “a plurality” are understood to include any integral number greater than or equal to two, i.e. two, three, four, five, etc. “At least one of” as used herein in connection with a list means that the list is inclusive of each element individually, as well as combinations of two or more elements of the list, and combinations of at least one element of the list with like elements not named.

References to numerical ranges with lower and upper endpoints herein include all numbers subsumed within the range (including fractions), whether explicitly recited or not, as well as the endpoints of the range. Thus, “1 to 5” includes 1, 2, 3, 4, and 5 when referring to, for example, a number of elements, and can also include 1.5, 2, 2.75, 3.8, or any other decimal amount when referring to, for example, quantitative measurements.

All method steps described herein can be performed in any suitable order unless otherwise indicated herein or otherwise clearly contradicted by context.

The use of any and all examples, or exemplary language (e.g., “such as” or “for example”), is intended merely to better illustrate an embodiment and does not represent a limitation on the scope of the invention or any embodiments unless indicated otherwise by context.

Any combination or permutation of features, functions and/or embodiments disclosed herein is likewise considered herein disclosed. Additional features, functions, or applications of the compositions, methods, and systems, disclosed herein will be apparent from the disclosure, particularly when read in conjunction with the appended figures. Any references listed in this disclosure are hereby incorporated by reference in their entireties.

What is claimed is:

1. A nonflammable solvent composition comprising, based on the total weight of trans-1,2-dichloroethylene, (E)-1-chloro-2,3,3-trifluoroprop-1-ene, and (Z)-1-chloro-2,3,3-trifluoroprop-1-ene:
about 80 wt. % to about 99.99 wt. % of trans-1,2-dichloroethylene; and
about 0.01 wt. % to about 20 wt. % of at least one of (E)-1-chloro-2,3,3-trifluoroprop-1-ene or (Z)-1-chloro-2,3,3-trifluoroprop-1-ene;
wherein the nonflammable solvent composition has no fire point over a temperature range of 10° C. to the boiling point of the solvent composition, measured according to any one or more of ASTM D92-18, ASTM D1310-14, or ASTM D56-22.

2. The nonflammable solvent composition of claim 1, comprising:
greater than 97 wt. % to about 99.99 wt. % of trans-1,2-dichloroethylene; and
about 0.01 wt. % to less than 3 wt. % of at least one of (E)-1-chloro-2,3,3-trifluoroprop-1-ene or (Z)-1-chloro-2,3,3-trifluoroprop-1-ene.

3. The nonflammable solvent composition of claim 1, wherein the nonflammable solvent composition is non-azeotropic.

4. A method of preparing a nonflammable solvent composition from trans-1,2-dichloroethylene, comprises mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition has no fire point over a temperature range of 10° C. to the boiling point of the solvent composition, measured according to any one or more of ASTM D92-18, ASTM D1310-14, or ASTM D56-22.

5. The method of preparing a nonflammable solvent composition from trans-1,2-dichloroethylene of claim 4, the method comprising mixing the trans-1,2-dichloroethylene with about 0.01 wt. % to less than 3 wt. % of the at least one of (E)-1-chloro-2,3,3-trifluoroprop-1-ene or (Z)-1-chloro-2,3,3-trifluoroprop-1-ene to form the nonflammable solvent composition.

6. A method for increasing the fire point of trans-1,2-dichloroethylene comprising mixing the trans-1,2-dichloroethylene with about 0.01 wt. % to about 20 wt. % of at least one of (E)-1-chloro-2,3,3-trifluoroprop-1-ene or (Z)-1-chloro-2,3,3-trifluoroprop-1-ene, based on the total weight of trans-1,2-dichloroethylene, (E)-1-chloro-2,3,3-trifluoroprop-1-ene, and (Z)-1-chloro-2,3,3-trifluoroprop-1-ene, to form a nonflammable solvent composition, wherein the nonflammable solvent composition is nonflammable over a temperature range of 10° C. to the boiling point of the composition, measured according to any one or more of ASTM D-92-18, ASTM D-1310-14, or ASTM D-56-22, and has no fire point at the boiling point of the composition.

7. The method for increasing the fire point of trans-1,2-dichloroethylene of claim 6, comprising mixing the trans-1,2-dichloroethylene with about 0.01 wt. % to less than 3 wt. % of the at least one of (E)-1-chloro-2,3,3-trifluoroprop-1-ene or (Z)-1-chloro-2,3,3-trifluoroprop-1-ene to form the nonflammable solvent composition.

8. The method of claim 7, wherein the nonflammable solvent composition is nonflammable over a temperature range of 10° C. to the boiling point of the composition, and a pressure range of about 0.5 to about 2 atmospheres, measured according to any one or more of ASTM D-92-18, ASTM D-1310-14, or ASTM D-56-22, and has no fire point at the boiling point of the composition.

9. A coating composition comprising the nonflammable solvent composition of claim 1 and a material dissolved or dispersed in the nonflammable solvent composition.

10. A mold release composition comprising the nonflammable solvent composition of claim 1 and at least one mold release additive dispersed in the nonflammable solvent composition.

11. An aerosol cleaner comprising the nonflammable solvent composition of claim 1 and an aerosol propellant.

12. The aerosol cleaner of claim 11, comprising:
about 50 to about 99 wt. % of the nonflammable solvent composition; and
about 1 to about 50 wt. % of the aerosol propellant comprising at least one of carbon dioxide, ethane, a haloalkene liquefied gas, or a haloalkane liquefied gas.

13. The aerosol cleaner of claim 12, wherein, the aerosol propellant comprises carbon dioxide or carbon dioxide in combination with at least one of a hydrofluorocarbon (HFC), hydrofluoroolefin (HFO), or hydrochlorofluoroolefin (HCFO) liquefied gas.

14. A cleaning composition comprising:
the nonflammable solvent composition of claim 1; and
at least one cleaning additive;
wherein the cleaning composition dissolves a greater range of contaminants or materials comprising one or more of polar substances, ionic substances, salts, or water-soluble compounds than the solvent composition alone.

15. The cleaning composition of claim 14, wherein the cleaning additive comprises at least one of methanol, ethanol, 1-propanol, 2-propanol, hexane, benzene, surfactants, fluorosurfactants, ketones, fluoroketones, silanes, siloxanes, ethoxylates, or methoxylates.

16. A method of preparing a foam, the method comprising preparing a foam composition comprising the nonflammable solvent composition of claim 1 as a blowing agent.

17. A method of cleaning a surface of an article comprising applying the nonflammable solvent composition of claim 1 to the surface of the article.

18. A method of coating a substrate with a material comprising:
dissolving or dispersing the material in the nonflammable solvent composition of claim 1 to form a coating composition;
applying the coating composition to the substrate to form a continuous coating composition film disposed on the substrate; and
evaporating the nonflammable solvent composition from the coating composition film to form a continuous film of the material disposed on the substrate.

19. The method according to claim 18, wherein the material comprises at least one of an oil, wax, lubricant, pesticide, insecticide, fungicide, synthetic polymer, biopolymer, or coating binder.

20. A method for transferring heat comprising circulating a heat transfer composition comprising the nonflammable solvent composition of claim 1 through a temperature gradient, wherein the heat transfer composition transfers heat from a heat source to a heat sink.
